(19) United States
(12) Patent Application Publication
(10) Pub. No.: US 2011/0063249 A1
(43) Pub. Date: Mar. 17, 2011

(54) TOUCH SENSING APPARATUS AND TOUCH SENSING METHOD

(75) Inventors: Shih Tzung Chou, Hsinchu County (TW); Yong Nien Rao, Hsinchu City (TW); Zong Lin Wu, Sanchong City (TW); Yu Kuang, Hsinchu City (TW)

(73) Assignee: RAYDIUM SEMICONDUCTOR CORPORATION, Hsinchu (TW)

(21) Appl. No.: 12/881,499

(22) Filed: Sep. 14, 2010

(30) Foreign Application Priority Data
Sep. 14, 2009 (TW) 098130888

(51) Int. Cl. G06F 3/045

(52) U.S. Cl. 345/174

(57) ABSTRACT

A touch sensing apparatus applied to a capacitance touch panel includes a sensing module, a signal generating module, a comparing module, and a processing module. When a first and a second touch point formed on the capacitance touch panel correspond to two first and second touch pad sets, the sensing module generates a request signal. The signal generating module respectively outputs two test signals with reverse phases to the two first touch pad sets according to the request signal. After the comparing module generates a compared result according to two voltage values corresponding to the two second touch pad sets, the processing module will determine the positions of the first and the second touch point according to the compared result. When touch points are more than two, the touch sensing apparatus repeats the above-mentioned steps until all positions of the touch points are defined and the ghost points are removed.

### CROSS-REFERENCE TO RELATED APPLICATIONS

This non-provisional application claims priority under 35 U.S.C. §119(a) on patent application no(s). 098130888 filed in Taiwan, R.O.C. on Sep. 14, 2009, the entire contents of which are hereby incorporated by reference.

### BACKGROUND OF THE INVENTION

1. Field of the Invention

The invention relates to a touch panel. In particular, the present invention relates to a touch sensing apparatus and a touch sensing method capable of preventing wrong judgment effectively and achieving multi-touch on capacitance touch panel.

2. Description of the Prior Art

In general, the touch panels can be divided into different types, such as the resistance type, the capacitance type, the ultrasonic type, optical type, according to their sensing theorems. Wherein, the capacitance touch panel can sense a slight touch, and there is almost no wearing damage generated by the touch between the finger and the touch panel, so that it is stable and has long life. Therefore, the capacitance touch panel can show better performance than the conventional resistance type touch panel.

Please refer to FIG. 1A and FIG. 1B. FIG. 1A and FIG. 1B show the conventional touch sensing apparatus 1 and its control signal input timing diagram. As shown in FIG. 1A and FIG. 1B, the conventional touch sensing circuit will orderly input pulsed square waves from the signal input module 12 to the touch pads X₁˜X₆ and Y₁˜Y₆ on the touch panel from the X-axis direction to the Y-axis direction (or from the Y-axis direction to the X-axis direction) in a time sharing way. Then, the sensing module 14 will sense the change of the parasitic capacitance generated when the pointing object (e.g., a finger or a touch pen tip) touches the panel, and further detect the touch action of the user and the position of the touch point formed on the panel.

However, when the user performs multiple touches on the capacitance type touch panel, the above-mentioned conventional sensing circuit structure and its sensing method will only sense the range of the touch points, but fail to determine the real positions of the touch points. For example, when the user uses two fingers to touch the capacitance touch panel, the conventional sensing circuit will detect two maximum values of the parasitic capacitance changes. However, since these two maximum values can be generated through two different touch ways, the system fails to precisely determine it is which one of the two ways, and these points not really touched are called “ghost points”.

FIG. 2A and FIG. 2B show schematic diagrams of the conventional touch sensing circuit sensing two touch points. As shown in FIG. 2A, if the user forms two touch points A and B on the touch panel 10, the sensing circuit will detect two maximum values of the parasitic capacitance changes on the X-axis, and also detect two maximum values of the parasitic capacitance changes on the Y-axis. At this time, the touch sensing circuit fails to determine the above-mentioned parasitic capacitance changes are caused by the two touch points A and B, or the two touch points A′ and B′. The touch points A′ and B′ shown in FIG. 2A are ghost points. Similarly, as shown in FIG. 2B, when the user forms two touch points C and D on the touch panel 10, two ghost points C′ and D′ will be generated.

Therefore, the invention provides a touch sensing apparatus and a touch sensing method to solve the above-mentioned problems.

### SUMMARY OF THE INVENTION

An embodiment of the invention is a touch sensing apparatus. In practical applications, the touch sensing apparatus can be applied to a capacitance touch panel to sense the position of at least one touch point formed on the capacitance touch panel. The capacitance touch panel includes a plurality of first touch pad sets arranged along a first direction and a plurality of second touch pad sets arranged along a second direction.

In this embodiment, the touch sensing apparatus includes a sensing module, a signal generating module, a comparing module, and a processing module. When a first touch point and a second touch point formed on the capacitance touch panel correspond to two first touch pad sets and two second touch pad sets respectively, the sensing module generates a request signal.

Then, the signal generating module respectively outputs two test signals with reverse phases to the two first touch pad sets according to the request signal. After the comparing module generates a compared result according to two voltage values corresponding to the two second touch pad sets, the processing module will determine a first position of the first touch point and a second position of the second touch point on the capacitance touch panel according to the compared result.

In fact, the touch sensing apparatus can also determine multiple touch points more than 2. When touch points are more than 2, the touch sensing apparatus repeats the above-mentioned steps until all positions of the touch points are defined and the ghost points are removed.

Another embodiment of the invention is a touch sensing method. The touch sensing method is used to sense the position of at least one touch point formed on a capacitance touch panel. Wherein, the capacitance touch panel includes a plurality of first touch pad sets arranged along a first direction and a plurality of second touch pad sets arranged along a second direction.

In this embodiment, the touch sensing method includes the steps of: (a) sensing whether a first touch point and a second touch point formed on the capacitance touch panel correspond to two first touch pad sets and two second touch pad sets respectively; (b) if the sensing result of step (a) is yes, outputting two test signals with reverse phases to the two first touch pad sets respectively; (c) measuring two voltage values corresponding to the two second touch pad sets and comparing the two voltage values to generate a compared result; (d) determining a first position of the first touch point and a second position of the second touch point according to the compared result. In fact, the touch sensing apparatus can also determine multiple touch points more than 2. When touch points are more than two, the touch sensing apparatus repeats the above-mentioned steps until all positions of the touch points are defined and the ghost points are removed.

The advantage and spirit of the invention may be understood by the following recitations together with the appended drawings.

### BRIEF DESCRIPTION OF THE APPENDED DRAWINGS

FIG. 1A illustrates a schematic diagram of the conventional capacitance touch sensing apparatus.

FIG. 1B illustrates a control signal input timing diagram of the conventional capacitance touch sensing apparatus.

FIG. 2A and FIG. 2B show schematic diagrams of the conventional touch sensing circuit sensing two touch points.

FIG. 3 illustrates a functional block diagram of a touch sensing apparatus according to an embodiment of the invention.

FIG. 4A and FIG. 4B illustrate a schematic diagram of the touch sensing apparatus sensing different two touch points.

FIG. 5 illustrates a flowchart of the touch sensing method according to an embodiment of the invention.

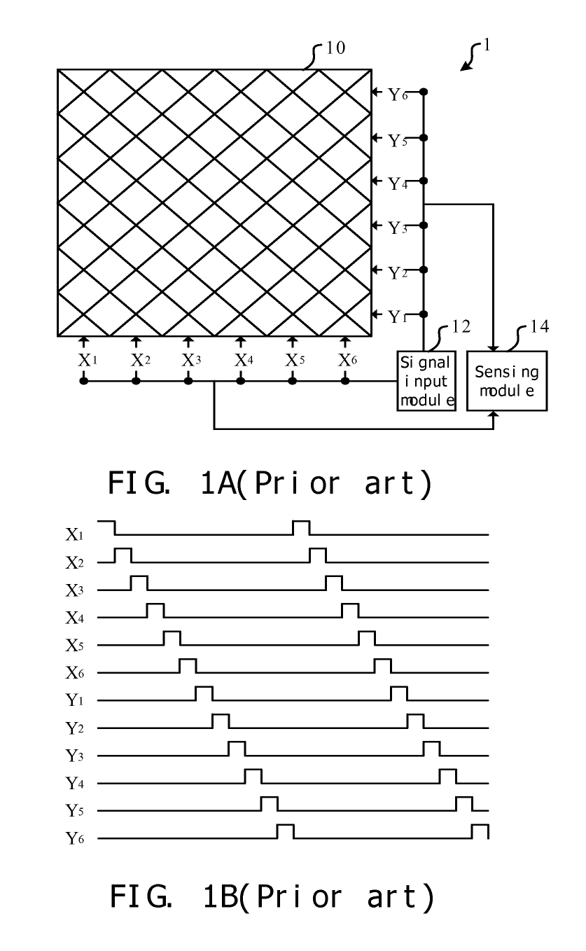

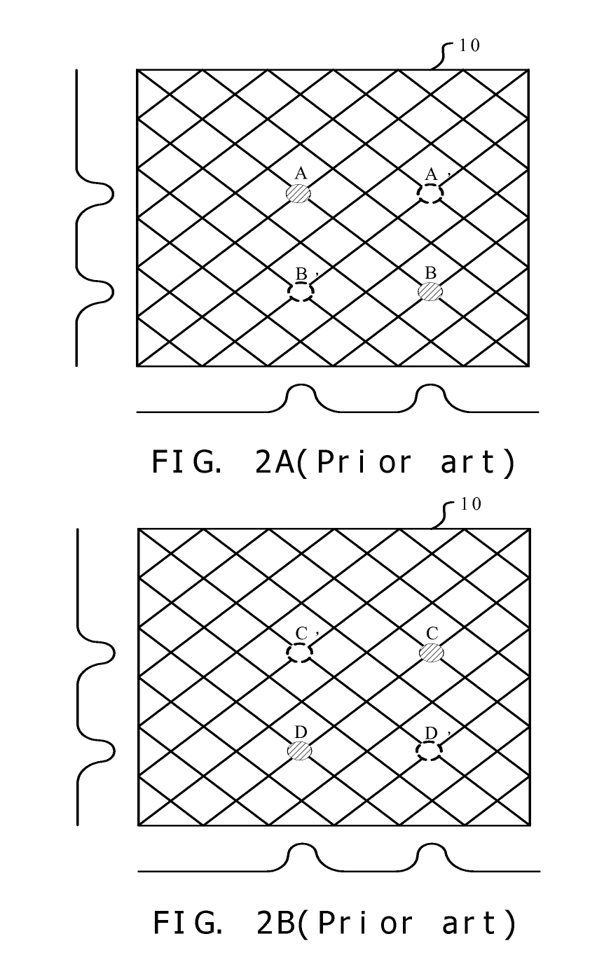

### DETAILED DESCRIPTION OF THE INVENTION

An embodiment of the invention is touch sensing apparatus. In this embodiment, the touch sensing apparatus is applied to a capacitance touch panel to sense the position of the at least one touch point formed on the capacitance touch panel. In fact, the object forming the touch point on the capacitance touch panel can be a finger or a touch pen tip of the user, but not limited to this case.

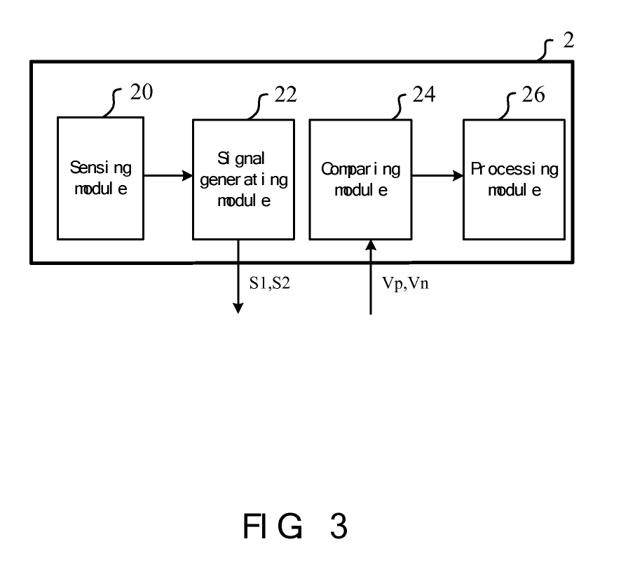

Please refer to FIG. 3. FIG. 3 shows a functional block diagram of the touch sensing apparatus in this embodiment. As shown in FIG. 3, the touch sensing apparatus 2 includes a sensing module 20, a signal generating module 22, a comparing module 24, and a processing module 26. Wherein, the sensing module 20 is coupled to the signal generating module 22; the comparing module 24 is coupled to the processing module 26; the signal generating module 22 will generate and output a first test signal S1 and a second test signal S2; the comparing module 24 will receive a first voltage Vp and a second voltage Vn.

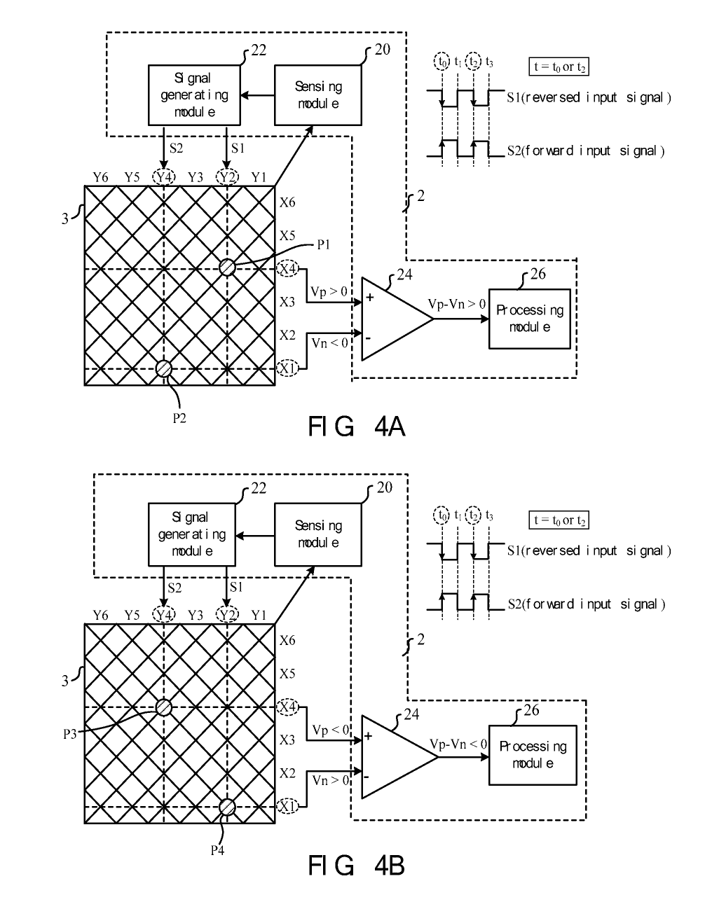

Then, please refer to FIG. 4A. FIG. 4A shows the touch sensing apparatus 2 of FIG. 3 applied to the capacitance touch panel 3. As shown in FIG. 4A, the capacitance touch panel 3 includes (6×6) touch points, 6 sets of first touch pad sets Y1˜Y6, and 6 sets of second touch pad sets X1˜X6. In this embodiment, the first touch pad sets Y1˜Y6 of the capacitance touch panel 3 are arranged along the first direction (Y-direction), and the second touch pad sets X1˜X6 are arranged along the second direction (X-direction). Wherein, the first direction can be vertical to the second direction, but not limited to this case. It should be noticed that the number of the touch points and the touch pad sets of the capacitance touch panel 3 is not limited to this case, it depends on practical needs. Next, how the touch sensing apparatus 2 senses and determines the two touch points P1 and P2 formed on the capacitance touch panel 3 will be introduced in detail.

As shown in FIG. 4A, the sensing module 20 of the touch sensing apparatus 2 is coupled to the capacitance touch panel 3. When a first touch point P1 and a second touch point P2 formed on the capacitance touch panel 3 correspond to two first touch pad sets of the first touch pad sets Y1˜Y6 and two second touch pad sets of the second touch pad sets X1˜X6 respectively, the sensing module 20 generates a request signal. In this case, since the first touch point P1 formed on the capacitance touch panel 3 corresponds to the first touch pad set Y2 and the second touch pad set X4, and the second touch point P2 corresponds to the first touch pad set Y4 and the second touch pad set X1, therefore, the sensing module 20 will generate the request signal to the signal generating module 22.

In this embodiment, the signal generating module 22 is coupled to the sensing module 20 and the first touch pad sets Y1˜Y6. After the signal generating module 22 receives the request signal from the sensing module 20, the signal generating module 22 respectively outputs a first test signal S1 and a second test signal S2 with reverse phases to the first touch pad sets Y2 and Y4 according to the request signal. In fact, the signal generating module 22 can be a pulse generator, and the first test signal S1 and the second test signal S2 are signals with reverse phases outputted by the signal generating module 22 at the same time, but not limited to this case.

In this embodiment, since the second touch pad set X4 is coupled to the positive end of the comparing module 24 and the second touch pad set X1 is coupled to the negative end of the comparing module 24, therefore, the comparing module 24 can receive the first voltage value Vp and the second voltage value Vn corresponding to the second touch pad sets X4 and X1 from the second touch pad sets X4 and X1 respectively, and compare the first voltage value Vp with the second voltage value Vn to generate a compared result. In practical applications, the comparing module 24 can be a comparator, but not limited to this case. In this case, the comparing module 24 can minus the second voltage value Vn from the first voltage value Vp to obtain a compared result Vp−Vn>0.

In this embodiment, the first test signal S1 and the second test signal S2 include a forward input signal and a reversed input signal. In fact, whether the first test signal S1 and the second test signal S2 are forward input signal or reversed input signal depends on whether the first test signal S1 and the second test signal S2 is positive-edge inputted or negative-edge inputted when the comparing module 24 compares the two voltage values, Vp and Vn.

For example, as shown in FIG. 4A and FIG. 4B, when the comparing time t=t₀ or t₂, since the first test signal S1 is negative-edge inputted and the second test signal S2 is positive-edge inputted, the first test signal S1 and the second test signal S2 are defined as the reversed input signal and the forward input signal. Therefore, Vp>0 and Vn<0 in FIG. 4A, so that the comparing module 24 will obtain the comparing result of Vp−Vn>0. Afterward, the processing module 26 will determine that the first touch point P1 and the second touch point P2 are under the first candidate touch mode, that is to say, the positions of the first touch point P1 and the second touch point P2 are (X4, Y2) and (X1, Y4) respectively, not the ghost touch points (X4, Y4) and (X1, Y2), therefore, wrong judgment of touch points in prior arts will be effectively prevented.

As to FIG. 4B, it can be found that Vp<0 and Vn>0, so that the comparing module 24 can obtain the compared result of Vp−Vn<0. Afterward, the processing module 26 can determine that the third touch point P3 and the fourth touch point P4 are under the second candidate touch mode according to the compared result of Vp−Vn<0, that is to say, the positions of the third touch point P3 and the fourth touch point P4 are (X4, Y4) and (X1, Y2).

The operating theorem of the above-mentioned method is: the pulses with reversed phase generated by the signal generating module 22 are inputted into the two first touch pad sets Y2 and Y4 touched by fingers respectively. After the finger touches the capacitance touch panel 3, the mutual capacitance between the first touch pad set and the second touch pad set in different directions will be reduced, therefore, the voltage signal coupled to the second touch pad sets X4 and X1 will be different, the real position of the two touch points can be distinguished accordingly.

It should be noticed that the touch sensing apparatus 2 can also determine multiple touch points more than 2. When the touch points are more than 2, the touch sensing apparatus 2 can repeat the above-mentioned steps until all positions of the touch points are defined and the ghost points are removed.

Another embodiment of the invention is a touch sensing method. The touch sensing method is used to sense the position of at least one touch point formed on a capacitance touch panel. Wherein, the capacitance touch panel includes a plurality of first touch pad sets arranged along a first direction and a plurality of second touch pad sets arranged along a second direction. In fact, the first direction is vertical to the second direction, but not limited to this case.

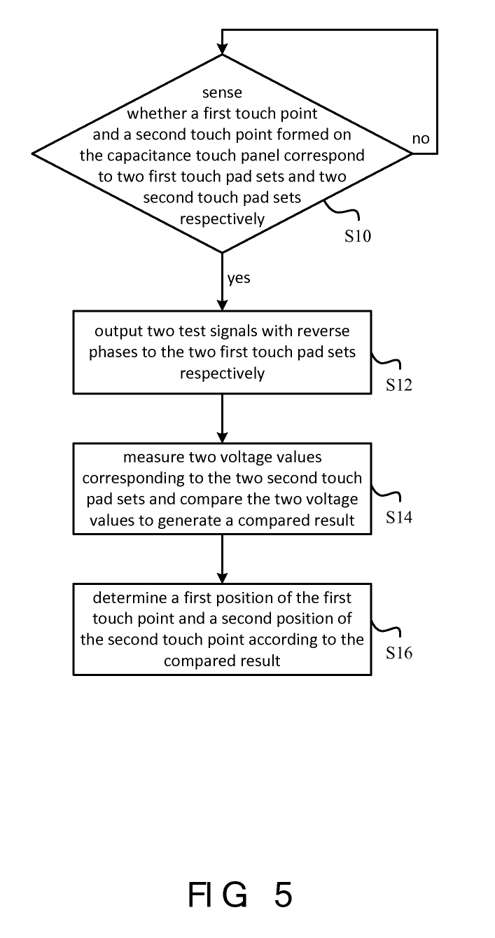

Please refer to FIG. 5. FIG. 5 illustrates a flowchart of the touch sensing method according to this embodiment. As shown in FIG. 5, at first, the method performs the step S10 to sensing whether a first touch point and a second touch point formed on the capacitance touch panel correspond to two first touch pad sets and two second touch pad sets respectively. If the sensing result of the step S10 is yes, the method performs the step S12 to output two test signals with reverse phases to the two first touch pad sets respectively. In fact, the two test signals are synchronization input signals with reversed phases. If the sensing result of the step S10 is no, the method will perform the step S10 again.

Then, the method performs the step S14 to measure two voltage values corresponding to the two second touch pad sets and compare the two voltage values to generate a compared result. Afterward, the method performs the step S16 to determine a first position of the first touch point and a second position of the second touch point according to the compared result.

In this embodiment, the first test signal S1 and the second test signal S2 include a forward input signal and a reversed input signal. In fact, whether the first test signal S1 and the second test signal S2 are forward input signal or reversed input signal depends on whether the first test signal S1 and the second test signal S2 is positive-edge inputted or negative-edge inputted when comparing the two voltage values. Please refer to FIG. 4A and FIG. 4B and related specification and the detail will not be described again here.

In practical applications, the above-mentioned step S16 can have two conditions. If the compared result is that the first voltage value of the two voltage values is larger than the second voltage value, the step S16 will firstly determine that the first touch point and the second touch point are under a first candidate touch mode, and determine the first position of the first touch point and the second position of the second touch point according to the first candidate touch mode. Wherein, the first position corresponds to the first specific first touch pad set and a first specific second touch pad set of the two second touch pad sets, and the second position corresponds to the second specific first touch pad set and a second specific second touch pad set of the two second touch pad sets.

On the contrary, if the compared result is that the first voltage value of the two voltage values is less than the second voltage value, the step S16 will firstly determine that the first touch point and the second touch point are under a second candidate touch mode, and determine the first position of the first touch point and the second position of the second touch point according to the second candidate touch mode. Wherein, the first position corresponds to the second specific first touch pad set and a first specific second touch pad set of the two second touch pad sets, and the second position corresponds to the first specific first touch pad set and a second specific second touch pad set of the two second touch pad sets.

It should be noticed that when the forward direction and the reversed direction of the first test signal and the second test signal are exchanged, the first candidate touch mode and the second candidate touch mode determined in step S16 will be also exchanged.

Above all, the touch sensing apparatus and the touch sensing method of the invention will generate pulses with reversed phases and input them to the two first touch pad sets of the capacitance touch panel touched by the finger. After the finger touches the capacitance touch panel, the mutual capacitance between the first touch pad set along the first direction and the second touch pad set along the second direction will be reduced, therefore, the voltage signal coupled to the corresponding second touch pad set will be different.

In addition, the touch sensing apparatus and method of the invention can also be used to determine multiple touch points, not limited to two touch points. When touch points are more than 2, the touch sensing apparatus repeats the above-mentioned steps until all positions of the touch points are defined and the ghost points are removed. By doing so, under the multiple touch points state, the touch sensing apparatus and method can effectively distinguish the difference between the real touch points and ghost points according to whether the difference between the voltage values is positive, and further position the real positions of the plurality of touch points formed on the capacitance touch panel.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch sensing apparatus, applied to a capacitance touch panel, the capacitance touch panel comprising a plurality of first touch pad sets aligned along a first direction and a plurality of second touch pad sets aligned along a second direction, the touch sensing apparatus comprising:
a sensing module, coupled to the capacitance touch panel, when a first touch point and a second touch point formed on the capacitance touch panel correspond to two of the plurality of first touch pad sets and two of the plurality of second touch pad sets, the sensing module generating a request signal;
a signal generating module, coupled to the sensing module and the plurality of first touch pad sets, for respectively outputting two test signals with reverse phases to the two first touch pad sets according to the request signal;
a comparing module, coupled to the two second touch pad sets, for measuring two voltage values corresponding to the two second touch pad sets and comparing the two voltage values to generate a compared result; and
a processing module, coupled to the comparing module, for determining a first position of the first touch point and a second position of the second touch point on the capacitance touch panel according to the compared result.

2. The touch sensing apparatus of claim 1, wherein the first direction is vertical to the second direction.

3. The touch sensing apparatus of claim 1, wherein the two test signals comprises a first test signal and a second test signal inputted by a first specific first touch pad set and a second specific first touch pad set of the two first touch pad sets respectively.

4. The touch sensing apparatus of claim 3, wherein under a specific time when comparing module compares the two voltage values, if the first test signal is negative-edge inputted and the second test signal is positive-edge inputted, the first test signal and the second test signal are defined as a reversed input signal and a forward input signal respectively.

5. The touch sensing apparatus of claim 4, wherein the two second touch pad sets comprises a first specific second touch pad set and a second specific second touch pad set, the first specific second touch pad set is coupled to a positive end of the comparing module and the second specific second touch pad set is coupled to a negative end of the comparing module.

6. The touch sensing apparatus of claim 5, wherein if a first voltage value of the two voltage values is positive and a second voltage value of the two voltage values is negative, the compared result is that the first voltage value minuses the second voltage value is larger than 0, the processing module determines that the first touch point and the second touch point are under a first candidate touch mode.

7. The touch sensing apparatus of claim 6, wherein under the first candidate touch mode, the first position of the first touch point corresponds to the first specific first touch pad set and the first specific second touch pad set, and the second position of the second touch point corresponds to the second specific first touch pad set and the second specific second touch pad set.

8. The touch sensing apparatus of claim 5, wherein if a first voltage value of the two voltage values is negative and a second voltage value of the two voltage values is positive, the compared result is that the first voltage value minuses the second voltage value is less than 0, the processing module determines that the first touch point and the second touch point are under a second candidate touch mode.

9. The touch sensing apparatus of claim 8, wherein under the second candidate touch mode, the first position of the first touch point corresponds to the second specific first touch pad set and the first specific second touch pad set, and the second position of the second touch point corresponds to the first specific first touch pad set and the second specific second touch pad set.

10. A touch sensing method, applied to a capacitance touch panel, the capacitance touch panel comprising a plurality of first touch pad sets arranged along a first direction and a plurality of second touch pad sets arranged along a second direction, the touch sensing method comprising the steps of:
(a) sensing whether a first touch point and a second touch point formed on the capacitance touch panel correspond to two of the plurality of first touch pad sets and two of the plurality of second touch pad sets;
(b) if the sensed result of the step (a) is yes, respectively outputting two test signals with reverse phases to the two first touch pad sets;
(c) measuring two voltage values corresponding to the two second touch pad sets and comparing the two voltage values to generate a compared result; and
(d) determining a first position of the first touch point and a second position of the second touch point on the capacitance touch panel according to the compared result.

11. The touch sensing method of claim 10, wherein the first direction is vertical to the second direction.

12. The touch sensing method of claim 10, wherein the two test signals comprises a first test signal and a second test signal inputted by a first specific first touch pad set and a second specific first touch pad set of the two first touch pad sets respectively.

13. The touch sensing method of claim 12, wherein under a specific time when comparing the two voltage values, if the first test signal is negative-edge inputted and the second test signal is positive-edge inputted, the first test signal and the second test signal are defined as a reversed input signal and a forward input signal respectively.

14. The touch sensing method of claim 13, wherein the two second touch pad sets comprises a first specific second touch pad set and a second specific second touch pad set, the first specific second touch pad set is coupled to a positive end of the comparing module and the second specific second touch pad set is coupled to a negative end of the comparing module.

15. The touch sensing method of claim 14, wherein if a first voltage value of the two voltage values is positive and a second voltage value of the two voltage values is negative, the compared result is that the first voltage value minuses the second voltage value is larger than 0, the step (d) comprises the steps of:
determining that the first touch point and the second touch point are under a first candidate touch mode; and
determining the first position of the first touch point and the second position of the second touch point according to the first candidate touch mode;
wherein the first position of the first touch point corresponds to the first specific first touch pad set and the first specific second touch pad set, and the second position of the second touch point corresponds to the second specific first touch pad set and the second specific second touch pad set.

16. The touch sensing method of claim 14, wherein if a first voltage value of the two voltage values is negative and a second voltage value of the two voltage values is positive, the compared result is that the first voltage value minuses the second voltage value is less than 0, the step (d) comprises the steps of:
determining that the first touch point and the second touch point are under a second candidate touch mode; and
determining the first position of the first touch point and the second position of the second touch point according to the second candidate touch mode;
wherein the first position of the first touch point corresponds to the second specific first touch pad set and the first specific second touch pad set, and the second position of the second touch point corresponds to the first specific first touch pad set and the second specific second touch pad set.
